(19) United States
(12) Patent Application Publication
(10) Pub. No.: US 2013/0229796 A1
(43) Pub. Date: Sep. 5, 2013

(54) LIGHT EMITTING DIODE BAR AND LIGHT EMITTING DIODE MODULE USING THE SAME

(71) Applicants: Chien-Chun Tseng, Gaoshu Township (TW); Chia-Lun Tsai, Dacheng Township (TW); Ya-Pei Tseng, Zhongpu Township (TW); Chien-Chang Chen, Taipei City (TW)

(72) Inventors: Chien-Chun Tseng, Gaoshu Township (TW); Chia-Lun Tsai, Dacheng Township (TW); Ya-Pei Tseng, Zhongpu Township (TW); Chien-Chang Chen, Taipei City (TW)

(73) Assignee: LEXTAR ELECTRONICS CORPORATION, Hsinchu (TW)

(21) Appl. No.: 13/616,446

(22) Filed: Sep. 14, 2012

(30) Foreign Application Priority Data
Mar. 3, 2012 (TW) 101107237

(51) Int. Cl. F21S 4/00

(52) U.S. Cl. 362/225

(57) ABSTRACT

A light emitting diode (LED) bar and an LED module using the same are provided. The LED bar includes a long shaped substrate, a plurality of first LEDs and a second LED. Two long parallel edges of the long shaped substrate are extended along a first direction. The long shaped substrate includes a non-connecting area and a connecting area located at an end of the long shaped substrate. The first LEDs are interlaced and disposed in the non-connecting area and between the two long sides. Each first LED has a first long axis disposed along the first direction. The second LED has a second long axis disposed in the connecting area and along a second direction. The first direction and the second direction are intersected at a predetermined angle.

This application claims the benefit of Taiwan application Serial No. 101107237, filed Mar. 3, 2012, the subject matter of which is incorporated herein by reference.

### BACKGROUND OF THE INVENTION

1. Field of the Invention

The invention relates in general to a light bar and a module using the same, and more particularly to a light emitting diode (LED) bar and an LED bar module using the same.

2. Description of the Related Art

The light-emitting diode (LED) emits a light by converting electric energy into photo energy. The LED is mainly composed of semiconductors. Of the semiconductors, those having a larger ratio of holes carrying positive electricity are referred as P type semiconductors, and those having a larger ratio of electrons carrying negative electricity are referred as N type semiconductors. The joint connecting a P type semiconductor and an N type semiconductor forms a PN joint. When a voltage is applied to the positive polarity and negative polarity of an LED chip, the electrons and the holes will be combined and emitted in the form of a light.

Having the features of long lifespan, low temperature and high energy utilization rate, the LED has been widely used in the fields such as screen backlight source, desk lamp, night light, large sign board, traffic light, third brake light, mobile phone boot-up indicator, and has gradually replaced conventional light sources.

The LEDs can be disposed on a long shaped substrate to form a LED bar. When the LED bars are serially connected, the length of the light source can further be increased. However, the design of serial connection needs to consider structural reliability, electrical and optical performance of the product. To improve product quality, the research personnel are engaged in associated researches.

### SUMMARY OF THE INVENTION

The invention is directed to a light emitting diode (LED) bar and an LED module using the same. The dark stripes of the connected LED bars are improved by rotating the LEDs at the connecting areas.

According to an embodiment of the present invention, a light emitting diode bar is provided. The LED bar includes a long shaped substrate, a plurality of first LEDs and a second LED. Two long parallel edges of the long shaped substrate are extended along a first direction. The long shaped substrate includes a non-connecting area and a connecting area located at an end of the long shaped substrate. The first LEDs are interlaced and disposed in the non-connecting area and between the two long sides. Each first LED has a first long axis disposed along the first direction. The second LED has a second long axis disposed in the connecting area and along a second direction. The first direction and the second direction are intersected at a predetermined angle.

According to another embodiment of the present invention, an LED module is provided. The LED module includes two LED bars. Each LED bar includes a long shaped substrate, a plurality of first LEDs and a second LED. Two long parallel edges of the long shaped substrate are extended along a first direction. The long shaped substrate includes a non-connecting area and a connecting area located at an end of the long shaped substrate. The first LEDs are interlaced and disposed in the non-connecting area of the long shaped substrate and between the two long sides. Each first LED has a first long axis disposed along the first direction. The second LED has a second long axis disposed in the connecting area and along a second direction. The first direction and the second direction are intersected at a predetermined angle. The predetermined angle is between 30 to 70 degrees. The distance between the second LED and the edge of the end of the long shaped substrate is substantially two times that between any two neighboring first LEDs along the first direction. The LED bar further includes a solder bump disposed in the connecting area. Two neighboring LED bars are connected by soldering the solder bumps located in the connecting areas at two neighboring ends of the two neighboring LED bars with a wire.

According to an alternate embodiment of the present invention, an LED module. The LED module includes two LED bars. Each LED bar includes a long shaped substrate, a plurality of first LEDs and a second LED. Two long parallel edges of the long shaped substrate are extended along a first direction. The long shaped substrate includes a non-connecting area and a connecting area located at an end of the long shaped substrate. The first LEDs are interlaced and disposed in the non-connecting area of the long shaped substrate and between the two long sides. Each first LED has a first long axis disposed along the first direction. The second LED has a second long axis disposed in the connecting area and along a second direction. The first direction and the second direction are intersected at a predetermined angle. The predetermined angle is between 30 to 70 degrees. The distance between the second LED and the edge of an end of the long shaped substrate is substantially two times that between any two neighboring first LEDs along the first direction. Each LED bar further includes a connector disposed in the connecting area. Two neighboring LED bars are connected by two connectors located at two neighboring ends of the two neighboring LED bars.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an LED module of a first embodiment; and

FIG. 2 shows a schematic diagram of an LED module of a second embodiment.

### DETAILED DESCRIPTION OF THE INVENTION

A number of embodiments are disclosed below for elaborating the invention. The dark stripes occurring to the connected LED bars are improved by rotating the LEDs at the connecting areas. The embodiments disclosed below are for exemplification purpose only, not for limiting the scope of protection of the invention. Furthermore, secondary or unimportant elements are omitted in the accompanying diagrams of the embodiments for highlighting the technical features of the invention.

### First Embodiment

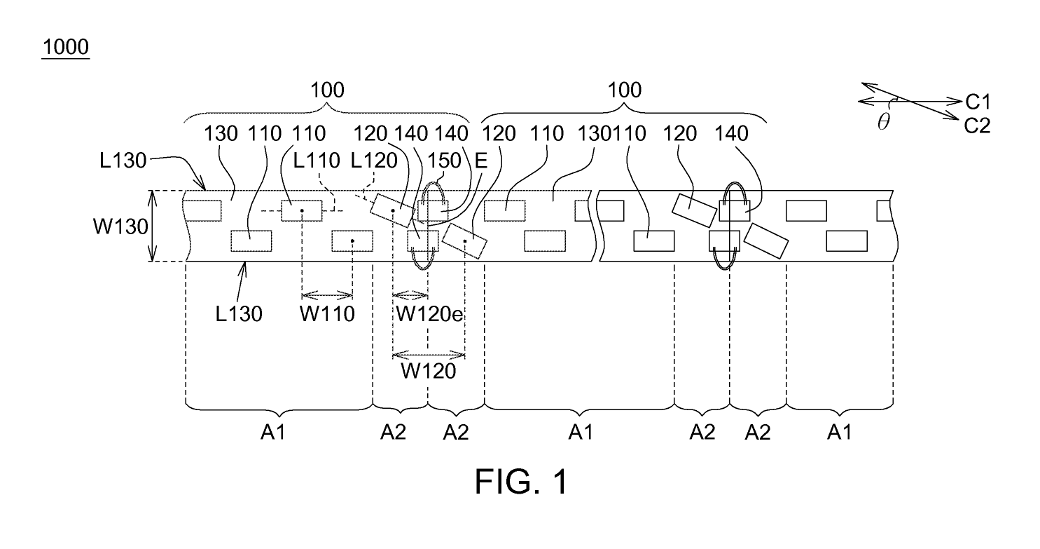

Referring to FIG. 1, a schematic diagram of an LED module 1000 of a first embodiment is shown. The LED module 1000 includes at least two LED bars 100. A plurality of LED bars 100 can be serially connected to form a long shaped light emitter. The number of LED bars 100 connected in serial can be determined according to the needs of the products.

The LED bar 100 includes a long shaped substrate 130, a plurality of first LEDs 110 and at least a second LED 120. The long shaped substrate 130 is used for supporting various electronic elements such as a single-sided circuit board, a double-sided circuit board, a silicon substrate or an aluminum substrate. The first LED 110 and the second LED 120 are used for emitting a light and are formed by such as AlGaAs, AlGaP, AlGaInP, GaAsP, GaP, GaN, InGaN or AlGaN. If the first LED 110 and the second LED 120 are formed by different materials, then they will emit different lights. The wavelengths of the lights emitted by the first LED 110 and the second LED 120 can be the same or different.

The long shaped substrate 130 includes a non-connecting area A1 and two connecting areas A2. In one embodiment, the long shaped substrate 130 can have only one connecting area A2 located at an end E of the long shaped substrate 130. The non-connecting area A1 is located in the middle of the long shaped substrate 130 and occupies a large part of the long shaped substrate 130. The connecting area A2 is used for connecting two neighboring long shaped substrates 130.

In the present embodiment, the LED bar 100 further includes a solder bump 140 disposed in the connecting area A2. Two neighboring LED bars 100 can be connected by soldering two neighboring solder bumps 140 with a wire 150.

In terms of the position of the first LED 110, two long sides L130 of the long shaped substrate 130 are extended along a first direction C1. The first LEDs 110 are interlaced and disposed in the non-connecting area A1 of the long shaped substrate 130 and between two long sides L130. Each first LED 110 has a first long axis L110 disposed along the first direction C1.

In the present embodiment, the first LEDs 110 are arranged in two rows, and are interlaced between the first row and the second row to shorten the intervals between the first LEDs 110 along the first direction C1.

In terms of the position of the second LED 120, the second LED 120 having a second long axis L120 is disposed in the connecting area A2 along a second direction C2. The first direction C1 and the second direction C2 are intersected at a predetermined angle θ. The second long axis L120 of the second LED 120 is not disposed along the first direction C1 but is inclined to the first direction C1, such that the second LEDs 120 of two neighboring LED bars 100 are closer to each other to avoid dark stripes occurring to two neighboring LED bars 100.

When the second LED 120 is rotated, the interference between the second LED 120 and the first LED 110, the restriction in the width W130 of the long shaped substrate 130, and the position of the solder bump 140 all need be taken into consideration. After several experiments, the research personnel found that when the predetermined angle θ is between 30 to 70, the above restrictions are satisfied and the dark stripes are improved. Considering the fact that the second LED 120 may have different emitting angles in different directions, the light emitted by the second LED 120 can be better used when the predetermined angle θ is equal to 30, 45, or 70 degrees.

As indicated in FIG. 1, after the second LED 120 is rotated, the distance W120e between the second LED 120 and the edge of the end E of the long shaped substrate 13 is substantially two times the distance W110 between any two neighboring first LEDs 110 along the first direction C1. Thus, the distance W120 between the neighboring second LEDs 120 can be shortened to improve the phenomena of dark stripes.

### Second Embodiment

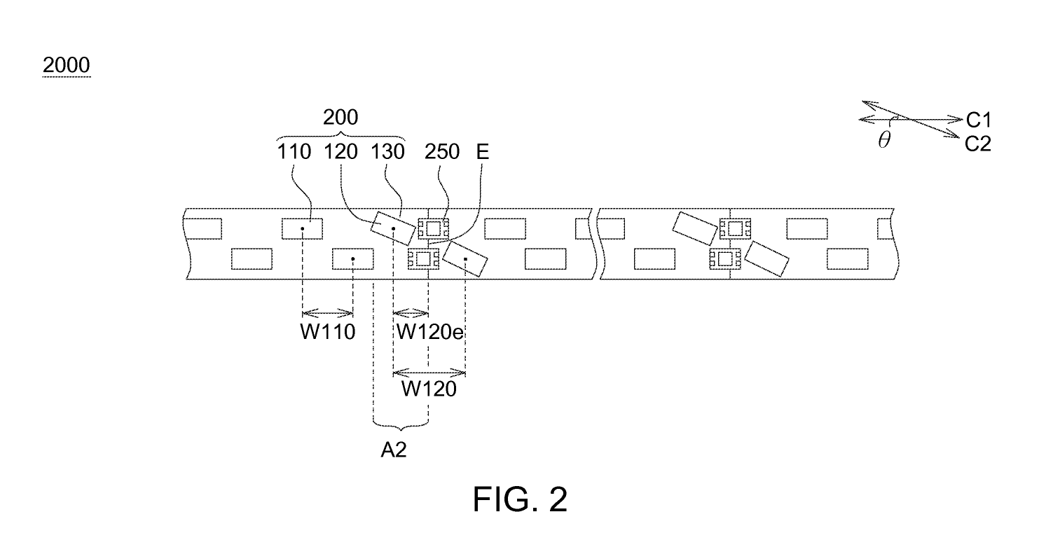

Referring to FIG. 2, an LED module 2000 of a second embodiment is shown. The LED module 2000 of the present embodiment is different from the LED module 1000 of the first embodiment in the connection method of the neighboring LED bar 200, and other similarities are not repeated.

As indicated in FIG. 2, the LED bar 200 further includes a connector 250 disposed in the connecting area A2. The connector 250 is such as a wire to wire connector, a wire to board connector, a board to board connector or a flexible printed circuit (FPC) connector.

Despite the LED bars 200 are connected via the connector 250, after the second LED 120 is rotated, the distance W120e between the second LED 120 and the edge of the end E of the long shaped substrate 130 is substantially two times the distance W110 between any two neighboring first LEDs 110 along the first direction C1. Thus, the distance W120 between neighboring seconds LED 120 can be shortened to improve the phenomena of dark stripes.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting diode (LED) bar, comprising:
a long shaped substrate whose two long parallel edges are extended along a first direction, wherein the long shaped substrate comprises a non-connecting area and a connecting area located at an end of the long shaped substrate;
a plurality of first LEDs interlaced and disposed in the non-connecting area between the two long sides, wherein each first LED has a first long axis disposed along the first direction; and
a second LED having a second long axis disposed in the connecting area along a second direction, wherein the first direction and the second direction are intersected at a predetermined angle.

2. The LED bar according to claim 1, wherein the predetermined angle is between 30 to 70 degrees

3. The LED bar according to claim 2, wherein the predetermined angle is 30, 45 or 70 degrees

4. The LED bar according to claim 2, wherein the distance between the second LED and the edge of the end of the long shaped substrate is substantially two times that between any two neighboring first LEDs along the first direction.

5. The LED bar according to claim 4, further comprising a solder bump disposed in the connecting area.

6. The LED bar according to claim 4, further comprising a connector disposed in the connecting area.

7. The LED bar according to claim 5, wherein the wavelength of the light emitted by the first LEDs is the same with that emitted by the second LED.

8. The LED bar according to claim 6, wherein the wavelength of the light emitted by the first LEDs is the same with that emitted by the second LED.

9. The LED bar according to claim 5, wherein the wavelength of the light emitted by the first LEDs is the different from that emitted by the second LED.

10. The LED bar according to claim 6, wherein the wavelength of the light emitted by the first LEDs is the different from that emitted by the second LED.

11. An LED module, comprising:
more than two LED bars according to claim 5, wherein the neighboring LED bars are connected by soldering two solder bumps located in two connecting areas at two neighboring ends of the two neighboring LED bars with a wire.

12. An LED module, comprising:
more than two LED bars according to claim 6, wherein the neighboring LED bars are connected by two connectors located at two neighboring ends of the two neighboring LED bars.
